(19) United States
(12) Patent Application Publication
(10) Pub. No.: US 2007/0247284 A1
(43) Pub. Date: Oct. 25, 2007

(54) Column based antenna array employing antenna field shaping for use in the automatic determination of network cable connections using RFID tags

(76) Inventors: Clifford E. Martin, Martinsville, NJ (US); Wee Teck Ng, Berkeley Heights, NJ (US); Cuong Tran, Howell, NJ (US)

Correspondence Address: Lucent Technologies Inc.;Docket Administrator, Room 3J-219, 101 Crawfords Corner Road, Holmdel, NJ, 07733-3030, US

(21) Appl. No.: 11/401,995

(22) Filed: Apr. 11, 2006

(51) Int. Cl. H04Q 5/22

(52) U.S. Cl. 340/10.1; 340/572.8; 439/488; 324/66; 702/183; 340/687

(57) ABSTRACT

A method and apparatus for the automatic determination of cable connections on a patch panel employs a reduced number of RFID antennas. A plurality of RFID antennas, each positioned so as to be in close proximity to each of a set of device ports of a patch panel, each comprises a series of resonators that correspond to the individual device ports (i.e., cable connector locations) in the set. The resonators may comprise in-line circuitry within the antennas, or other means for producing given impedance values at the cable connector locations. In operation, the power supplied to a given antenna is varied (e.g., in a step-wise fashion), so that the antenna field may be advantageously shaped to include a given subset of the device ports in the set and to exclude the others, thereby allowing the system to read individual RFID tags (connected to particular device ports) selectively.

### FIELD OF THE INVENTION

The present invention relates generally to the field of Radio Frequency Identification (RFID) systems and more particularly to the use of RFID techniques for the automatic determination of network cable connections.

### BACKGROUND OF THE INVENTION

The management of complicated networks such as telecommunications networks or sophisticated computer networks is tremendously expensive. A substantial portion of this cost arises from incomplete, incorrect or ambiguous knowledge about a network. For example, a telecommunications network operator may not have an accurate record of how network switches are configured, leading to failed attempts to fix problems or provision new services. This lack of knowledge can in some instances be remedied by polling the networking equipment to determine its actual settings.

However, a more fundamental ambiguity arises at the physical level of network cable management. Network cables may be added, removed or moved by support personnel for a variety of reasons, often to solve urgent problems. However, it is very difficult to maintain an accurate record of exactly which cable is connected to which port of a given piece of equipment (e.g., a patch panel of a telecommunications switch), since the cables may so easily be connected, disconnected, and reconnected.

Typically, network cable locations and connections are tracked manually, by, for example, putting printed tags on each cable, storing the tag-to-cable mappings in a database, and then attempting to manually keep the database up to date. In addition, physical inventories of network offices, in which the cables are identified, tagged and mapped, are themselves typically performed manually. In a large telecommunications or computer network system, it is an extremely expensive proposition to keep track of every cable, where it is, where it runs, and which port on a given piece of equipment it is plugged into. As a result, equipment inventory databases are notoriously inaccurate, and the negative results include, inter alia, loss of network capacity, increased service times and a much greater chance of disruptive service errors. Thus, it would be highly advantageous if there were an automated mechanism able to identify the connections between cables and equipment ports of a given piece of equipment such as, for example, a patch panel of a telecommunications switch.

One approach is to use Radio Frequency Identification (RFID) systems for the automatic determination of cable connections, by employing RFID tags on both cable ends and equipment ports, determining each of their respective locations (with use of one or more RFID sensing devices), and then determining the physical proximity therebetween. Based on this determined physical proximity, juxtaposition (e.g., a connection) between the cable and the port can be determined. This approach is described in detail in U.S. Pat. No. 6,847,856, “Method For Determining Juxtaposition Of Physical Components With Use of RFID Tags” by Philip L. Bohannon, issued Jan. 25, 2005 and commonly assigned to the assignee of the present invention. U.S. Pat. No. 6,847,856 is hereby incorporated by reference as if fully set forth herein.

Another approach to the use of Radio Frequency Identification (RFID) systems for the automatic determination of cable connections might comprise the use of RFID tags on each cable end and a single, independent receiver (e.g., antenna) at (or near to) each device port. Then, the specific cable end that is connected to each device port (if any) can be advantageously determined by merely reading the ID value of the connected cable end. This, however, might be prohibitively expensive. (As is familiar to those of ordinary skill in the art, whereas RFID tags are extremely inexpensive, RFID readers are typically not so inexpensive.)

A better approach is to use an RF antenna grid, employed on a device having a plurality of device ports (e.g., cable end connection points), which may, for example, be physically organized in a two-dimensional rectangular arrangement. (As used herein, a “device port” is any physical receptacle into which an end of a cable may be connected. The receptacle and cable may, for example, be adapted to carry electrical or optical signals, but they are not necessarily limited thereto. Also as used herein, the term “antenna grid” is not meant to imply any particular arrangement of antennas or device ports to which it is employed, but rather represents any antenna arrangement in which either multiple device ports are associated with a given RFID antenna and/or in which two or more distinct antennas are associated with a given device port.) In particular, each of the RFID antennas may be advantageously located on the device such that it is in close physical proximity to each of two or more device ports. (As used herein, the term “close physical proximity” between an RFID antenna and a device port is defined by the ability of the RFID antenna to sense the presence of an RFID tag attached to a cable end which has been plugged into the device port when directed to do so by an RFID reader.)

This is the approach employed in co-pending U.S. patent application Ser. No. 10/812,598, “Method And Apparatus For The Automatic Determination Of Network Cable Connections Using RFID Tags And An Antenna Grid,” filed on Mar. 30, 2004 by Clifford E. Martin (hereinafter, “Martin”) and commonly assigned to the assignee of the present invention. In particular, Martin discloses a method and apparatus whereby an RF antenna grid is advantageously employed on a device (e.g., a patch panel) having a plurality of device ports (e.g., cable connection points) which may, for example, be physically organized in a two-dimensional rectangular arrangement. Then, when RFID tags have been fixed to one or more cable ends, it can advantageously be determined which of the one or more cables are connected to which of the device ports on the patch panel.

The RF antenna grid of Martin may comprise a plurality of individual antennas which are advantageously multiplexed such that a single RFID reader can handle the sensing for all antennas, and illustratively, is comprised of a corresponding row antenna for each row of device ports in the rectangular arrangement thereof, and a corresponding column antenna for each column of device ports in the rectangular arrangement thereof. Thus, for such a rectangular arrangement of device ports comprising m columns and n rows, a total of at least m+n antennas will be employed by the Martin technique. U.S. patent application Ser. No. 10/812,598 is hereby incorporated by reference as if fully set forth herein.

### SUMMARY OF THE INVENTION

We have recognized that with an appropriate antenna design, the row antennas used in Martin's disclosed antenna grid for use with a rectangular arrangement of device ports can be advantageously eliminated, thereby providing a method and apparatus for the automatic determination of cable connections employing a significantly reduced number of antennas (e.g., equal to the number of columns of device ports in a two-dimensional rectangular grid thereof, rather than equal to at least the sum of the number of columns plus the number of rows). In particular, in accordance with an illustrative embodiment of the present invention, each column antenna, positioned so as to be in close proximity to each of a set of device ports (e.g.; all device ports in a given column), advantageously comprises a series of resonators that correspond to the individual device ports (i.e., cable connector locations) in the set. Illustratively, these resonators may comprise in-line circuitry within the antennas, or other means for producing given impedance values at the cable connector locations. Then, in operation, the power supplied to a given antenna is varied (e.g., in a step-wise fashion), so that the antenna field may be advantageously shaped to include a given subset of the device ports in the set and to exclude the others, thereby allowing the system to read individual RFID tags (connected to particular device ports) selectively.

### BRIEF DESCRIPTION OF THE DRAWINGS

FIG. 1 shows an example of an apparatus comprising a patch panel having a plurality of RFID column antennas for the automatic determination of network cable connections in accordance with an illustrative embodiment of the present invention.

FIG. 2 shows a mathematical representation of an antenna design for the RFID antennas of the apparatus of FIG. 1, for use in the automatic determination of network cable connections in accordance with an illustrative embodiment of the present invention.

FIG. 3 shows one possible implementation for the antenna design of FIG. 2 in accordance with an illustrative embodiment of the present invention.

FIG. 4 shows a flowchart .of a sample method for the automatic determination of network cable connections in accordance with an illustrative embodiment of the present invention.

### DETAILED DESCRIPTION OF THE PREFERRED EMBODIMENTS

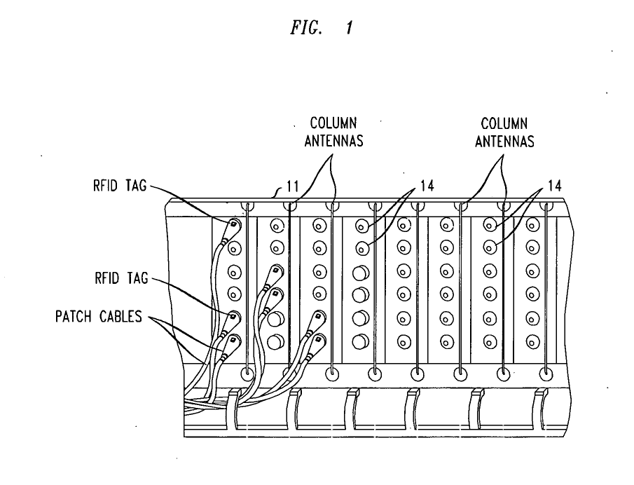

FIG. 1 shows an example of an apparatus comprising a patch panel having a plurality of RFID column antennas for the automatic determination of network cable connections in accordance with an illustrative embodiment of the present invention. The illustrative apparatus comprises patch panel 11 which comprises a plurality of device ports 14 which are arranged in a rectangular configuration. As such, each device port can be identified in terms of a physical column (e.g., horizontal position) number and a physical row (e.g., vertical position) number. As can be seen from the figure, the particular illustrative patch panel shown has 48 device ports, arranged in 8 (vertical) columns and 6 (horizontal) rows. In addition, note that certain ones of the device ports have corresponding patch cables connected thereto, each of which has a cable end (i.e., a plug) which advantageously has an RFID tag attached thereto. (Such RFID tags are conventional and are fully familiar to those of ordinary skill in the art.)

In accordance with the principles of the present invention, the illustrative apparatus of FIG. 1 further comprises a plurality of (i.e., eight) vertically oriented column antennas arranged such that each column antenna is in close physical proximity to each of the device ports in a corresponding column. In this manner, the presence of an RFID tag on a cable end which is connected to a given device port in a given column may be advantageously sensed by the column antenna associated with the given column.

Moreover, further in accordance with the principles of the present invention, each of these column antennas is advantageously designed in such a manner that the field generated by the antenna may be advantageously shaped to include a given subset of the device ports in the given column and to exclude the others, by appropriately varying the power level supplied to the antenna. Illustratively, each of the column antennas may be fashioned from a strip of copper or any other material which can operate as an RFID sensing antenna, and, in accordance with the principles of the present invention will further comprises a series of resonators that correspond to the individual device ports (i.e., cable connector locations) in the given column. (As described below, the resonators advantageously permit the above-described shaping of the antenna field.)

Preferably, column antennas associated with columns other than the one in which a given device port is located will not sense an RFID tag attached to a cable end which is connected to the given device port. As will be obvious to those skilled in the art, such an appropriate level of sensitivity may be advantageously ensured by appropriately limiting the power range and setting the frequency of the antenna pulsing process (i.e., the antenna reads), in order to control the sensing range of the RFID tags. Such adjustments are fully conventional and are well known by those of ordinary skill in the RFID art.

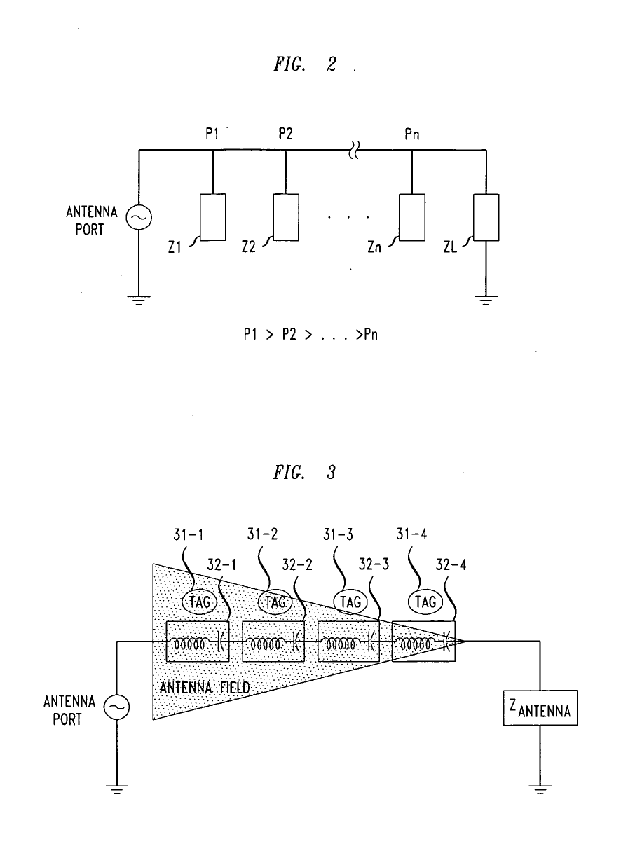

FIG. 2 shows a mathematical representation of an antenna design for the RFID antennas of the apparatus of FIG. 1, for use in the automatic determination of network cable connections in accordance with an illustrative embodiment of the present invention. Each antenna in accordance with the illustrative embodiment of the present invention may advantageously comprise a low profile, long wire with respect to a given wavelength, commonly known as a Beverage antenna. (Beverage antennas are fully conventional and are well known to those of ordinary skill in the art.) Advantageously, the field which radiates along the wire of a Beverage antenna is mostly uniform. However, in accordance with the principles of the present invention, a tapered power distribution is advantageously applied to an individual Beverage antenna as illustratively shown in FIG. 2.

Specifically, in accordance with the illustrative embodiment of the present invention as shown in the figure, resonators (Z1 through Zn) are placed along the wire and are advantageously designed to have different impedances so that the field strength at the “nearest” resonator, P1, is the strongest and the field strength at the “farthest” resonator, Pn, is the weakest. (The terms “nearest” and “farthest” are used herein to refer to the relative distance along the antenna from the RFID reader, which is the device conventionally used to “read”—namely, to sense the presence of any RFID tags near—an RFID antenna.) Thus, in accordance with the principles of the present invention, by appropriately controlling the signal strength to the RFID reader (i.e., by controlling the power applied to the antenna), individual RFID tags located along the path of the antenna can be advantageously read selectively.

In accordance with one illustrative embodiment of the present invention, the power distribution along the wire antenna can be expressed mathematically as follows:
For i=1 to n−1, Pᵢ₊₁=Pᵢ/xⁱ or, equivalently, Pᵢ=xⁱPᵢ₊
and, therefore,
Zᵢ₊₁=zᵢ/xⁱ or, equivalently, zᵢ=xⁱZᵢ₊₁
where x>1 is a constant value for determining the power control steps, and where P₁ is at a predetermined power level, which is the highest power level on the antenna.

For example, in accordance with one illustrative embodiment of the present invention, assume that the power control step is set to 3 decibels. Then:
x=2;
P₁=2P₂=4P₃= . . . 2ⁿ⁻¹Pₙ;
Z₁=2Z₂=4Z₃= . . . 2ⁿ⁻¹Zₙ;

In accordance with the illustrative embodiment of the present invention, we assume that all tags in the RFID system have the same (approximate) sensitivity level, Pₛₑₙₛ. In other words, the tags will be unable to detect any signal below this level. Then, in operation of the given illustrative embodiment of the present invention, the RFID reader advantageously begins scanning for tags at the nearest device port by supplying the appropriate signal level to give P₁=Pₛₑₙₛ, which ensures that any tag located at the nearest device port is detectable but that any tags located at a device port other than the nearest device port will be undetectable. In other words, only a tag located at resonator Z₁ will be identified. The reader then increases power to the next level (based on the value of the power control step - illustrative, as shown above, 3 decibels) and scans for tags using this power level, which ensures that any tag located at either the nearest device port or the second nearest device port is detectable but that any tags located at a device port other than the nearest or next-to-nearest device port will be undetectable. In other words, any tag located at resonator Z₂ will now be identified. The process advantageously proceeds in this manner until all tags along the antenna have been identified.

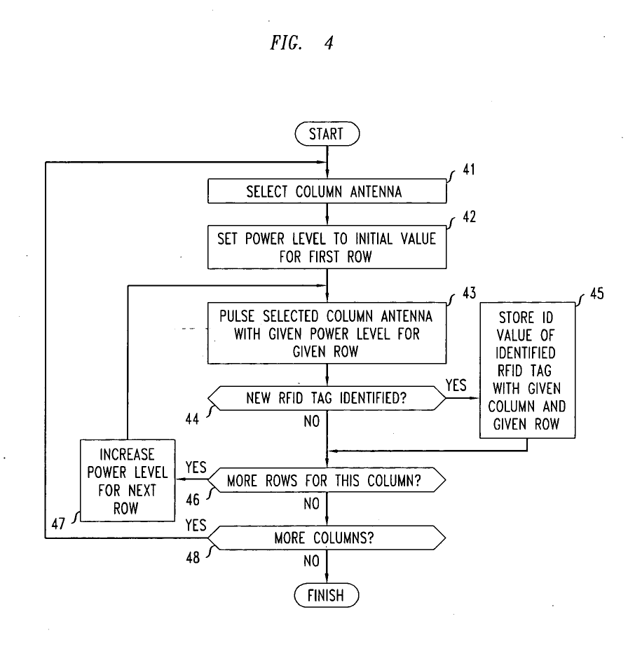

FIG. 3 shows one possible implementation for the antenna design of FIG. 2 in accordance with an illustrative embodiment of the present invention. In this illustrative embodiment of the present invention, each column antenna comprises a series of circuits which operate as the corresponding resonators of FIG. 2. In other words, resonator circuit 32-1 of FIG. 3 serves the function of resonator Z1 of FIG. 2, resonator circuit 32-2 of FIG. 3 serves the function of resonator Z2 of FIG. 2, resonator circuit 32-3 of FIG. 3 serves the function of resonator Z3 of FIG. 2, and resonator circuit 32-4 of FIG. 3 serves the function of resonator Z4 of FIG. 2. (In the illustrative embodiment shown in FIG. 3, it is assumed that the corresponding number of resonators as shown in FIG. 2 is four—i.e., n=4.) Each of the resonator circuits is advantageously located in close physical proximity to a corresponding device port of the patch panel, and, as illustratively shown in the figure (for the sake of clarity of explanation), it is assumed that in the instant case, there is an RFID tag—namely, RFID tags 31-1, 31-2, 31-3, and 31-4, respectively—associated with each of these device ports. As such, each resonator circuit shown in the figure is advantageously in close physical proximity to a corresponding RFID tag.

More specifically, the illustrative embodiment of FIG. 3 shows an antenna comprising a plurality of resonator circuits (32-1 through 32-4), each of which comprises an inductor and a capacitor in series with each other and in series with the other resonator circuits of the antenna. As pointed out above, this embodiment provides one possible implementation of the illustrative antenna design of FIG. 2. In particular, referring back to FIG. 2, and as described above, each of the individual resonators (labeled Z1 through Zn) may be advantageously designed independently to give a specific impedance and then attached to a desired location (e.g., relative to a corresponding device port) along the wire antenna. The resonator circuits of FIG. 3 show one such possible implementation thereof. In accordance with other illustrative embodiments of the present invention, other implementations may be used. For example, the resonators of FIG. 2 may, in the alternative, be implemented as open-ended stubs (i.e., short pieces of wire) or may be dielectric resonators, in either case being attached to the various, desired locations of the antenna wire.

Returning to the discussion of FIG. 3, it is to be noted that, in accordance with the principles of the present invention, the illustrative antenna design results in an antenna field (such as the one shown in the figure) when power is applied to the antenna (e.g., by the antenna port of FIG. 3, which may comprise an RFID reader), wherein the size and extent of the antenna field will clearly vary depending on the power applied. In particular, as is illustratively shown in the figure, the antenna field (as shown) is of a sufficient strength to capture (i.e., be able to sense the presence of) RFID tags 31-1 and 31-2, but not of a sufficient strength to capture (and therefore will exclude from capture) RFID tags 31-3 and 31-4. And, as described above, it is clear that by increasing or decreasing the strength of the antenna field (i.e., by increasing or decreasing the power level applied), more or less of the RFID tags will be captured (with the others excluded).

Based on the illustrative example of FIG. 3, it will be clear to those skilled in the art that incremental, step-wise increases in the power applied in the reading of an RFID antenna designed in accordance with the principles of the present invention will enable a system for the automatic determination of network cable connections using RFID tags to identify the presence of an RFID tag at any of the device ports for which the RFID antenna is in close proximity thereto. For example, in the illustrative example of a patch panel having a rectangular arrangement of device ports wherein each of one or more RFID “column” antennas are provided in close physical proximity to each of the device ports in a given column, the varying of the applied power in an appropriate step-wise manner (see illustrative example above in connection with the description of FIG. 2) will enable the identification of the presence of an RFID tag at any of the device ports in the given column.

FIG. 4 shows a flowchart of a sample method for the automatic determination of network cable connections in accordance with an illustrative embodiment of the present invention. The illustrative method for determining network cable connections on a patch panel having an essentially rectangular arrangement of device ports begins in block 41 by selecting (a first) one of the column antennas. Then, in block 42, the power level is set to an initial value for the first row—that is, a value which enables the given antenna to sense any RFID tags in the first row of the given column, but not sense any RFID tags in any other rows of the given column. In block 43 the selected RFID antenna is pulsed with the given power level (for the given row) to locate any RFID tags in the given row of the given column.

Decision block 44 of the flowchart then asks whether any new RFID tags have been identified. In other words, it determines whether any RFID tags that were not previously sensed by this antenna have now been sensed. If so, block 45 stores the ID of the identified RFID tag together with the given column number (of the given column antenna) and the given row number (associated with the given power level). In either case, decision block 46 then determines whether there are more (i.e., previously untested) rows for the given column, and if so, block 47 increases the power level in a step-wise fashion for the next row. In other words, it sets the power level such that any RFID tags in the given column and in a row less than or equal to the given row will be sensed, but that any RFID tags in the given column and in a row greater than the given row will not be sensed. Then, flow returns to block 43 for the given column antenna with the new (i.e., increased) given power level.

Finally, if decision block 46 determines that all of the rows for the given column have been processed, decision block 48 determines if there are more columns (i.e., column antennas) to be considered. If there are, flow returns to block 41 to select the next column antenna and the process is repeated. If decision block 48 determines that all column antennas have been completely examined, the illustrative process of FIG. 4 terminates.

### OTHER ILLUSTRATIVE EMBODIMENTS

Although the above description has been primarily directed to patch panels comprising a plurality of device ports arranged in a substantially rectangular array, it will be obvious to those skilled in the art that the principles of the present invention may be applied to a patch panel having essentially any physical of arrangement of device ports, in combination with one or more RFID antennas each in close physical proximity to each of a plurality of said device ports. Thus, in accordance with other illustrative embodiments of the present invention, one or more RFID antennas (each of which may have an essentially arbitrary shape and arrangement with respect to the patch panel and the device ports) is provided in close physical proximity to corresponding sets of device ports of a patch panel (upon which the device ports may be arranged in an essentially arbitrary arrangement), such that each of said RFID antennas is capable of identifying the presence of RFID tags located at any particular one of the device ports in the corresponding set thereof by varying the power level applied to the given RFID antenna in accordance with the principles of the present invention.

Addendum to the Detailed Description

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. In addition, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

What is claimed is:

1. An apparatus for use in determining connectivity between one or more device ports comprised in a patch panel and one or more cable ends having corresponding RFID tags attached thereto, the one or more cable ends being connected to corresponding ones of said one or more device ports of said patch panel, the apparatus comprising one or more RFID antennas, each of said RFID antennas being in close physical proximity to each of two or more of said plurality of device ports and comprising a plurality of resonators for providing a predetermined impedance at each of a corresponding plurality of predetermined locations along said RFID antenna, each of said plurality of resonators associated with a corresponding one of said device ports in close physical proximity to said RFID antenna.

2. The apparatus of claim further comprising an RFID reader for applying power at a given power level to said RFID antennas, to sense said RFID tags attached to cable ends which are connected to said corresponding ones of said one or more device ports of said patch panel.

3. The apparatus of claim 2 wherein said RFID reader comprises means for applying power at a plurality of different power levels to each of said RFID antennas, wherein applying power at different ones of said power levels to a given one of said RFID antennas senses RFID tags attached to cable ends which are connected to different subsets of said two or more device ports in close physical proximity to said given RFID antenna.

4. The apparatus of claim 3 wherein said different power levels comprise a sequence of monotonically increasing power level values, wherein each successive one of said power levels in said sequence, when applied to said given RFID antenna, senses RFID tags attached to cable ends which are connected to a subset of said two or more device ports in close physical proximity to said given RFID antenna which consists of all of the device ports in close physical proximity to said given RFID antenna which were included in said subset of said two or more device ports in close physical proximity to said given RFID antenna for which RFID tags attached to cable ends connected thereto were sensed by a previous one of said power levels in said sequence, and which further consists of one additional device port in close physical proximity to said given RFID antenna which was not included in said subset of said two or more device ports in close physical proximity to said given RFID antenna for which RFID tags attached to cable ends connected thereto were sensed by said previous one of said power levels in said sequence.

5. The apparatus of claim 1 wherein said RFID antennas comprise Beverage antennas.

6. The apparatus of claim 5 wherein said plurality of resonators comprised in said RFID antennas produce a tapered power distribution.

7. The apparatus of claim 6 wherein said plurality of resonators comprises a plurality of resonator circuits electrically in series with each other.

8. The apparatus of claim 7 wherein each of said resonator circuits comprises an inductor and a capacitor electrically in series with each other.

9. The apparatus of claim 6 wherein said plurality of resonators comprises a plurality of open-ended wire stubs.

10. The apparatus of claim 6 wherein said plurality of resonators comprises a plurality of dielectric resonators.

11. The apparatus of claim 1 wherein said device ports comprised in said patch panel are arranged in a substantially rectangular arrangement comprising a plural number of columns of device ports and a plural number of rows of device ports.

12. The apparatus of claim 11 wherein each of said RFID antennas is in close physical proximity to each device port in a corresponding one of said columns of said device ports.

13. A method for determining connectivity between one or more device ports comprised in a patch panel and one or more cable ends having corresponding RFID tags attached thereto, the one or more cable ends being connected to corresponding ones of said one or more device ports of said patch panel, the method for use with an apparatus comprising one or more RFID antennas, each of said RFID antennas being in close physical proximity to each of two or more of said plurality of device ports and comprising a plurality of resonators for providing a predetermined impedance at each of a corresponding plurality of predetermined locations along said RFID antenna, each of said plurality of resonators associated with a corresponding one of said device ports in close physical proximity to said RFID antenna, the method comprising the steps of:
applying power at a first power level to a given one of said RFID antennas to sense RFID tags attached to cable ends which are connected to a first subset of said two or more device ports in close physical proximity to said given RFID antenna;
increasing said first power level by a predetermined amount to determine a second power level;
applying power at the second power level to the given one of said RFID antennas to sense RFID tags attached to cable ends which are connected to the second subset of said two or more device ports in close physical proximity to said given RFID antenna, said second subset of said two or more device ports in close physical proximity to said given RFID antenna consisting of all of the device ports in close physical proximity to said given RFID antenna which were included in said first subset of said two or more device ports in close physical proximity to said given RFID antenna and further consisting of one additional device port in close physical proximity to said given RFID antenna which was not included in said first subset of said two or more device ports in close physical proximity to said given RFID antenna; and
identifying an RFID tag attached to a cable end which is connected to said additional device port in close physical proximity to said given RFID antenna which was not included in said first subset of said two or more device ports in close physical proximity to said given RFID antenna, said identifying based on said RFID tag attached to a cable end which is connected to said additional device port in close physical proximity to said given RFID antenna having been sensed when said second power level was applied to the given one of said RFID antennas but not having been sensed when said first power level was applied to the given one of said RFID antennas.

14. The method of claim 13 wherein said RFID antennas comprise Beverage antennas and wherein said plurality of resonators comprised in said RFID antennas produce a tapered power distribution.

15. The method of claim 14 wherein said plurality of resonators comprises a plurality of resonator circuits electrically in series with each other.

16. The method of claim 15 wherein each of said resonator circuits comprises an inductor and a capacitor electrically in series with each other

17. The method of claim 14 wherein said plurality of resonators comprises a plurality of open-ended wire stubs.

18. The method of claim 14 wherein said plurality of resonators comprises a plurality of dielectric resonators.

19. The method of claim 13 wherein said device ports comprised in said patch panel are arranged in a substantially rectangular arrangement comprising a plural number of columns of device ports and a plural number of rows of device ports.

20. The method of claim 19 wherein each of said RFID antennas is in close physical proximity to each device port in a corresponding one of said columns of said device ports.
